(19) United States
(12) Patent Application Publication
(10) Pub. No.: US 2015/0012402 A1
(43) Pub. Date: Jan. 8, 2015

(54) Trading System License Verification, Management and Control

(71) Applicant: Trading Technologies International, Inc., Chicago, IL (US)

(72) Inventor: Brian J. Buck, Livermore, CA (US)

(21) Appl. No.: 13/934,626

(22) Filed: Jul. 3, 2013

(51) Int. Cl. G06Q 40/04

(52) U.S. Cl. CPC G06Q 40/04
USPC 705/37

(57) ABSTRACT

A system and method for trade order verification. The system includes an exchange and a trading device. A license key associated with a trading device is communicated to the exchange. The license key is validated, at the exchange, against an authorized list. The trading device generates, and communicates to the exchange, a trade order relating to one or more tradeable objects traded at the exchange. The exchange executes the trade order if the license key is validated. A market update related to the trade order is communicated to the trading device.

### CROSS-REFERENCE TO RELATED APPLICATIONS

Not Applicable.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

The trading device is generally a computing device, such as a general purpose personal computer or microcomputer running a specialized piece of software. Typically, the trading software is licensed from a third party vendor, and operated by a trader or trading company. One of the issues related to such trading software is the verification that the trader or trading company is properly licensed to use the software.

Furthermore, trading companies may range to having a few employees or traders to hundreds of traders. A traditional licensing scheme, such as a “click license” upon installation of the software, does not ensure that every use or installation or use of the software is properly licensed.

Additionally, in addition to the variation in the number of traders which may be employed by a trading company, each trader may vary in the number or average number of orders which are placed. Traditional licensing schemes do not account for being able to track, and thus, perform license based on the trading volume of a trader (or per trader) or trading company.

The present disclosure is aimed at one or more of the issues as described above.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 is a flow diagram of a method for performing verification of a trade order, according to an embodiment of the present disclosure.

FIG. 5 is a flow diagram of another method for performing verification of a trade order, according to another embodiment of the present disclosure.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The present disclosure is related to a computer system which is used to electronically perform trades on an exchange, and more particularly, to a system which electronically verifies a license associated with software running on a trading device and/or performs usage reporting of the trading device. Such verification features may also be used in tracking usage, e.g., by the number of trades, per user (or trader) or trading company for the purpose of establishing licensing fees.

In one aspect of the present disclosure a license key is associated with each trading device. The license key may also be specific to a specific trader, group of traders, brokers and other trading entities. The license key may be transmitted to the exchange with each trade order. Alternatively, the license key may be provided by a trader when they log on, or transmitted periodically.

Orders are not executed unless the license key has been verified. In another embodiment, verified orders may be prioritized and transmitted ahead of unprioritized orders. Different priority levels having different degrees of access, communications priorities and features may be established to encourage usage of the trading software and/or direct trading volume to a particular or desired exchange.

Orders, and especially executed orders, may be tracked per trader and/or trading company for the purpose of generating license fees or invoices based on the tracked volume (number of orders or number of objects traded).

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

In one aspect of the present disclosure, a method performing for trade order verification is provided. The method includes the steps of communicating a license key associated with a trading device to an exchange and validating, at the exchange, the license key against an authorized list. A trade order, relating to one or more tradeable objects traded at the exchange, is generated via the trading device. The method further includes the steps of communicating the trade order to the exchange, executing, in response to validation of the license key, the trade order with respect to the one or tradeable objects, and communicating, to the trading device, a market update related to the trade order.

In another aspect of the present disclosure, a system for performing trade orders and trade order verification is provided. The system includes an exchange and a trading device. The trading device is coupled to the exchange and is configured to communicate a license key associated with a trading device to the exchange and to generate a trade order relating to one or more tradeable objects traded at the exchange. The exchange is configured to validate the license key against an authorized list, to execute, in response to validation of the license key, the trade order with respect to the one or tradeable objects, and to communicate, to the trading device, a market update related to the trade order.

In a further aspect of the present disclosure, a non-transitory computer-readable information recording medium, which stores a program for controlling a computer to performing trade orders and trade order verification at exchange, is provided. The program may be configured to operate the computer as a trading device coupled to the exchange. The trading device is configured to communicate a license key associated with a trading device to the exchange and to generate a trade order relating to one or more tradeable objects traded at the exchange. The trading device is further configured to execute, in response to validation of the license key against an authorized list at the exchange, the trade order with respect to the one or tradeable objects, and to receive, at the trading device, a market update related to the trade order.

### II. Example Electronic Trading System

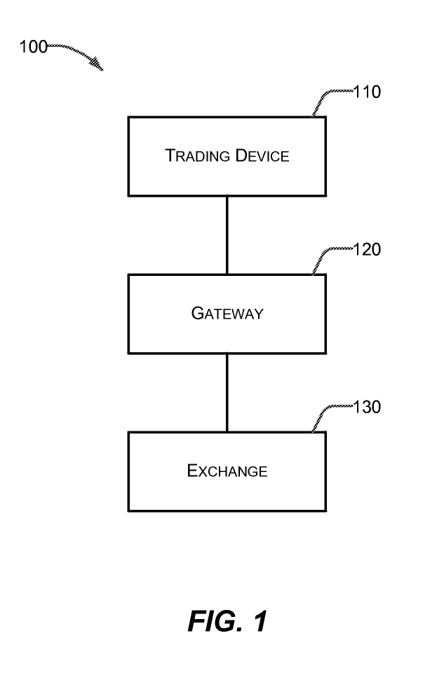

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange 130, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

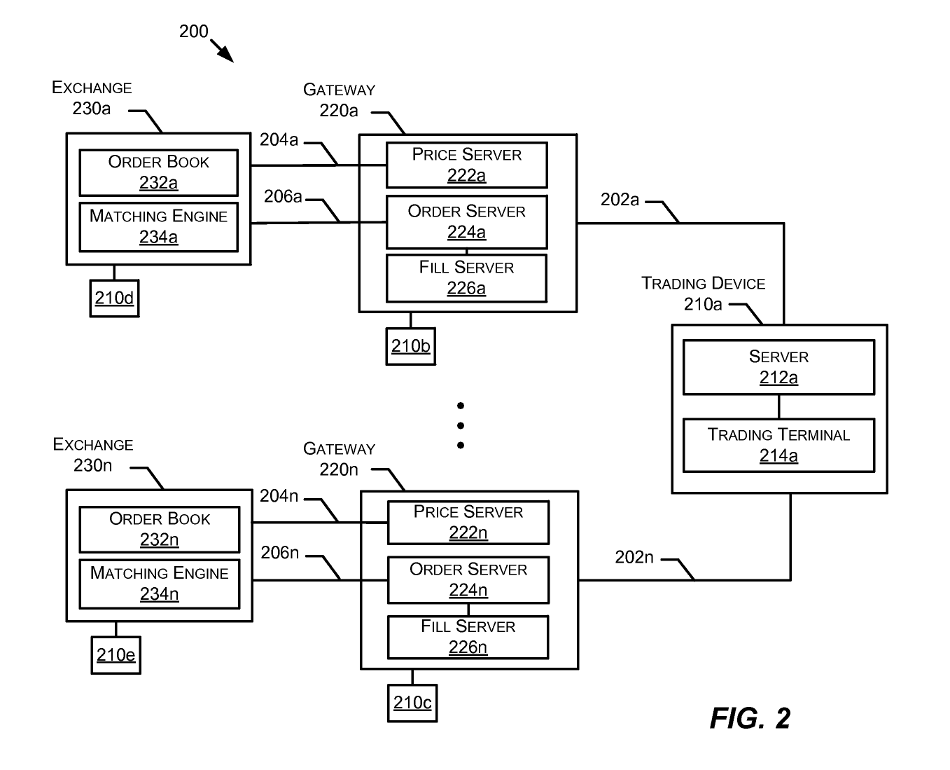

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 210a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 220a than the trading terminal 214a. As a result, the server 212a latency benefits are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates or enables communication between, for example, the trading device 210a, the gateway 220a and the exchange 230a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradeable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book 232a may include data relating to a market for a tradeable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. Example Computing Device

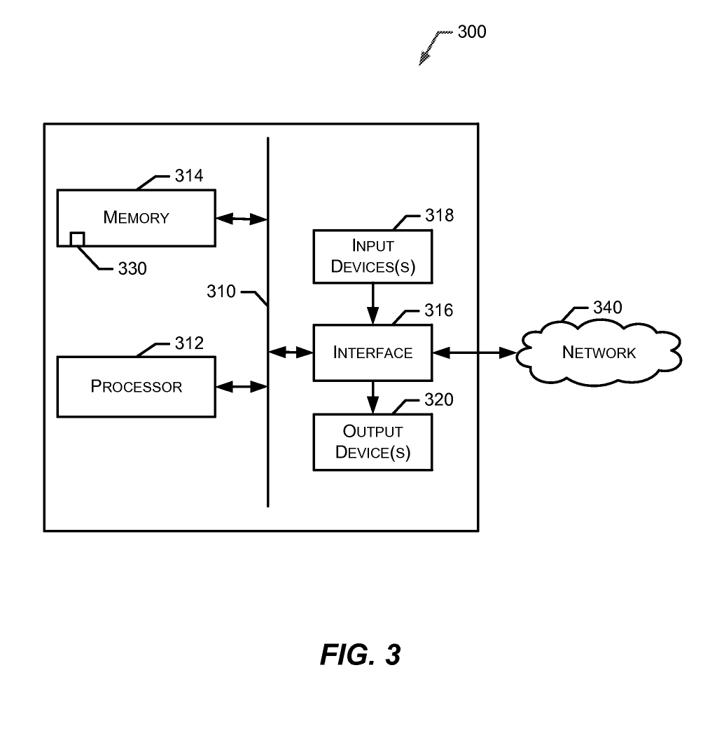

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

V. License Verification, Usage Reporting, and/or Certification Verification

With particular reference to FIG. 1, in one aspect of the present disclosure the system 100 is configured to authenticate and verify that the trading software executed by the trading device 110 is properly licensed and authorized to generate one or more trade orders. Additionally, the system 100 may be configured to utilize the verification feature to track usage, e.g., by the number of trades, per trader, per trader by broker or by an entire trading organization for the purpose of establishing licensing fees.

In one aspect of the present disclosure, the trading device 110 is configured to communicate a license key associated with a trading device to the exchange 130. In one embodiment, the license key is an encrypted file or message which includes information identifying or related to one or more of the following:
the name of the trading software being run by the trading device 110,
version of the trading software being run by the trading device 110,
a unique serial number of the trading software being run by the trading device 110,
an identification of the trading device 110,
an identification of a user or trader currently using or logged onto the trading device 110,
a vendor or supplier of the trading device 110 and/or the trading software, and,
the trading company associated with the trading device 110.

The license key may be communicated to the exchange 130 when, for example, a trader logs on to the system 100, periodically throughout a trading session, with every trade order communicated to the exchange 130 or any combination thereof.

In one embodiment, the exchange 130 may offer trade order tracking as a service that may be subscribed to by the traders, software providers or any other authorized an interested party. For example, the exchange 130 may include a list or database of qualified users or traders, trading devices, and/or trading companies. When the license key is received at the exchange 130, the exchange 130 compares the license key against the list and verifies that the license key is valid. For example, the license key may be determined to be valid if the information in the license key matches information stored in the list. The list or database of qualified users or traders may include other information such as a total number of trades, or the date or time at which a trade order was received that could be used to determine the validity of the license key. For example, after the exchange 130 receives a predetermined number of trade orders from a particular user or trader, the associated license key may be deactivated either permanently or temporarily. In another embodiment, the license key stored at the exchange 130 may be valid, for example, between the hours of 8 AM and 5 PM; for orders of a certain (i.e., predefined) size; based on the trader's position; and/or the contracts being traded.

As discussed above, the user or trader utilizes the trading software on the trading device 110 to generate a trade order relating to one or more tradeable objects traded at the exchange 130. The exchange 130 executes the trade order, if the license key has been validated, with respect to the one or more tradeable objects, and communicates, to the trading device 110, a market update related to the trade order.

In one embodiment, the license key is communicated to the exchange 130, and must be validated, with each order. In another embodiment, the license key is communicated when the user logs on to the system 100 and the authentication/validation is valid for (1) the entire session or (2) a predetermined time period or (3) until a predetermined event occurs, for example, the trading device 110 is inactive for a predetermined time period.

If the license key cannot be validated, e.g., the license to the trading software has expired, or the trader, trading software, vendor, trading company, etc. . . . , are not contained in the list, then the exchange 130 performs an appropriate action, which may include one or more of the following:

(a) denying the trade order,

(b) providing a warning to a trader associated with the trade order, and

(c) notify a vendor associated with the trading device.

In another aspect of the present disclosure, the exchange 130 may be configured to track a number of trades executed and to generate a report containing the number of trades executed. The number of trades may be tracked based on one or more criteria, including, but not limited to:
user or trader,
trading company,
trading device 110,
trading software and/or serial number of trading software, and
date and time.

In another aspect of the present disclosure, the report may be used to charge fees to the trader or trading company based on the actual usage of the trading software. For instance, the fees charged to the trader or trading company may be based on the total number or trades and/or the total volume of objects traded and/or the value of the trades and/or any combination of the above. Furthermore, the fees may be based on the amount of time that the trader is connected or active and receiving live market data (including price) updates, and/or by the number of unique tradable objects being traded and/or manipulated.

In a further aspect of the system 100, the trading device 110 may be configured to send a cryptographically-protected certification identifier to the exchange 130. The exchange 130 may be configured to verify the cryptographically protected certification identifier against a list maintained by the exchange 130 and to validate that the trading software, associated with the trading device 110, had been certified by the exchange 130 for operation with the exchange 130.

In another aspect of the system 100, the exchange 130 may contract to provide trade order tracking and usage information related to the trading software. For example, the exchange 130 may provide the tracking and usage information to the software vendor (not shown) responsible for the trading software. The software vendor, in turn, may utilize the tracking and usage information to generate billing statements, usage reports, and the like for the traders, brokers and other trading entities. The exchange 130 may be financially compensated for providing the usage and tracking information. In another example, the exchange 130 may provide the usage and tracking information in exchange for a guaranteed trade volume by users of the trading software. In this way, the software vendor may defer all or part of the cost associated with receiving the usage and tracking information by routing or otherwise directing trade orders to one or more preferred exchanges offering markets to trade one or more of the tradable objects of interest to the user.

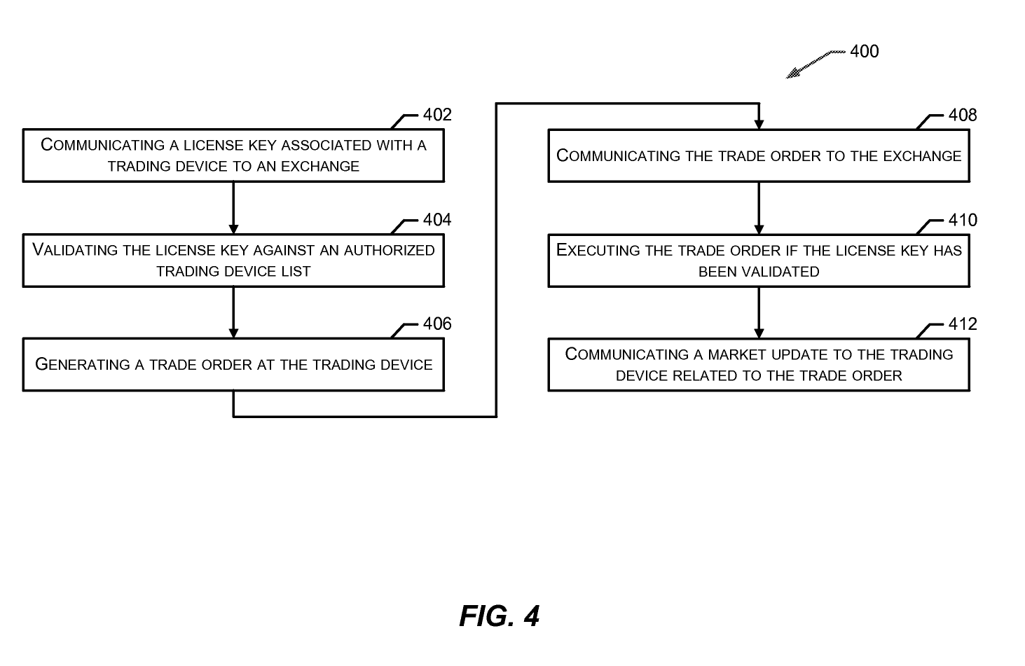

With reference to FIG. 4, in another aspect of the present disclosure, a method 400 for trade order verification is provided. The method includes a first step 402 of communicating a license key associated with a trading device 110 to an exchange 130. In a second step 404, the license key is validated at the exchange 130 against an authorized list. The trading device 110 generates (based on user or trader input) a trade order relating to one or more tradeable objects traded at the exchange 130 in a third step 406. In a fourth step 408, the trade order is communicated to the exchange 130. In a fifth step 410, if the license key has been validated (and any other contingencies associated with the trade order have been met), the trade order is executed with respect to the one or more tradeable objects. In a sixth step 412, a market update is sent, from the exchange 130, to the trading device 110 related to the offer. The market update may include, for example, the number of the one or more tradeable objects contained in the executed trade order and the price associated with the one or more tradeable objects.

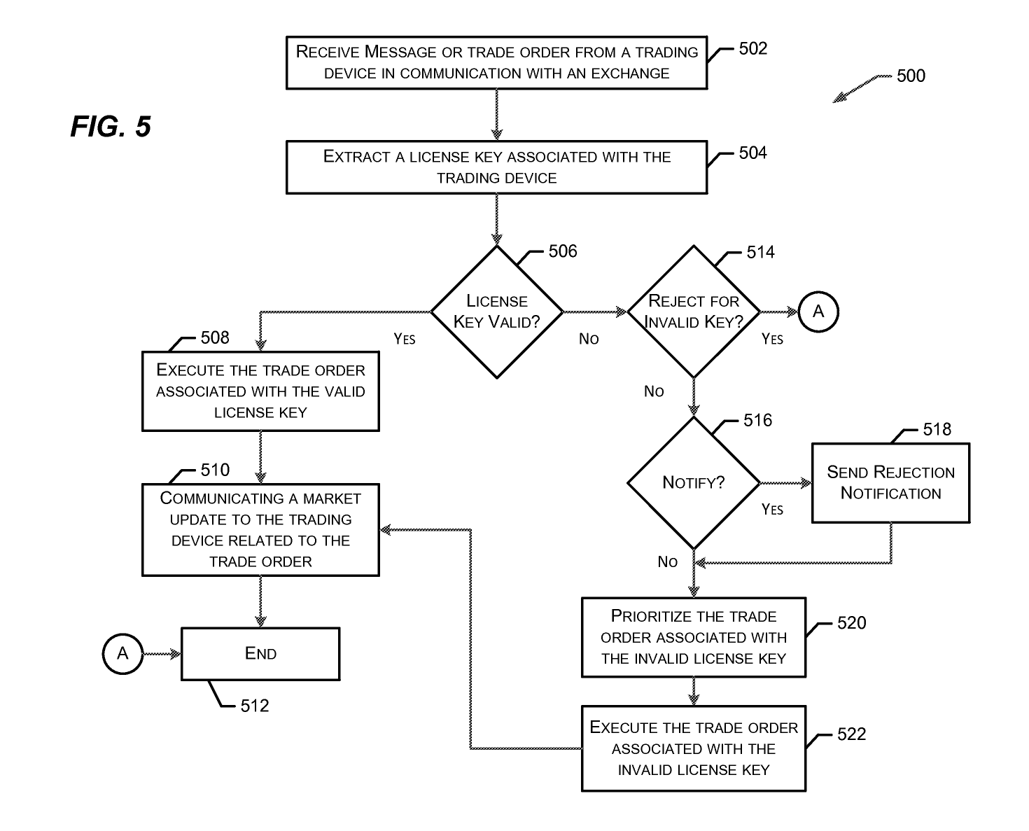

With reference to FIG. 5, in another aspect of the present disclosure, another method 500 for trade order verification is provided. The method includes a first step 502 of receiving a message such as a trade order, a log in request or other trading related communication from a trading device 110. In a second step 504, the method 500 may attempt to extract a license key from the received message. The license key may be communicated as part of the trade order. For example, the license key may be part of the received message header. The license key serves to associate the trading device 110 and trader the exchange 130. In a third step 506, the method 500 evaluates the license key against an authorized list maintained at the exchange 130. If the license key is determined to be valid, the method 500 may continue on to a fourth step 508 and execute the trade order. In a fifth step 510, the exchange 130 may communicate a confirmation and/or market update in response to the receipt and/or execution of the trader order. At a sixth step 512, the method 500 may conclude and await receipt of another message or trade order as indicated at step 502.

If, at step 506, the license key is determined to be invalid, not found or otherwise corrupt, the method 500 may continue on to a seventh step 514. At the seventh step 514, the method 500 may reject the message and/or trade order for having an invalid license key. If the message and/or trade is rejected, then the method 500 may conclude as indicated by the on-page reference identifier A. If the message and/or trade is not rejected, then the method 500 may proceed to the eighth step 516 and an alert or other notification of an invalid license may be communicated to the trading device 110 as indicated at step 518. The decision to reject the message and/or trade order may be based on one or more business rules. A business rule may be established to verify: the version of the license key; the time interval over which a license key is active, and that the license key has not be disabled or deactivated by an administrator. Once the decision to notify the trading device 110 of the rejection has been resolved, the method 500 may proceed to the ninth step 520. In the ninth step 520, the method 500 may prioritize or otherwise organize the message and/or trade order associated with the invalid license key. For example, the method 500 may designate any trade order associated with an invalid license key as a low priority order. Low priority orders may, for example, be delayed in execution or associated with a different, often higher, transaction fee cost. In certain embodiments, low priority orders may be held or otherwise queued pending outside intervention such as release by an administrator and/or deposit of additional funds. In another example, trade orders associated with the invalid license key may be executed without cost once trade orders with valid license keys have been executed. In the tenth step 522, the method 500 may execute the trade order associated with the invalid license key. In another embodiment, the method 500 may cancel the trade order associated with the invalid license key and proceed to the conclusion of the method to await additional orders containing a valid license key. Once the message or trader order has been executed, the method 500 may proceed to the fifth step 510 and communicate a confirmation and/or market update in response to the receipt and/or execution of the trader order. In the sixth step 512, the method 500 may conclude and await receipt of another message or trade order as indicated at step 502.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method for trade order verification, the method comprising:
communicating a license key associated with a trading device to an exchange;
validating, at the exchange, the license key against an authorized list;
generating, via the trading device, a trade order relating to one or more tradeable objects traded at the exchange;
communicating the trade order to the exchange;
executing, in response to validation of the license key, the trade order with respect to the one or tradeable objects; and,
communicating, to the trading device, a market update related to the trade order.

2. A method, as set forth in claim 1, wherein the trading device has an associated vendor, wherein the license key includes vendor identification information.

3. A method, as set forth in claim 1, wherein the license key includes software identification data associated with trading software running on the trading device.

4. A method, as set forth in claim 3, wherein the software identification data includes at least one of the name of the trading software, a version number of the trading software, and a serial number associated with the trading software.

5. A method, as set forth in claim 1, further including the step of allowing a trader to logon to the trading device, wherein the license key is communicated to the exchange during logon.

6. A method, as set forth in claim 1, including the step of performing at least one of the following in response to the license key not being validated:
(a) denying the trade order,
(b) providing a warning to a trader associated with the trade order, and
(c) notify a vendor associated with the trading device.

7. A method, as set forth in claim 1, wherein multiple trade orders are generated and communicated to the exchange, wherein the license key is communicated to the exchange with each trade order.

8. A method, as set forth in claim 7, including the steps of:
tracking, at the exchange, a number of trades executed; and,
generating a report containing the number of trades executed.

9. A method, as set forth in claim 8, wherein the report includes date and/or time information related to each trade, the method including the step of charging a trader or trading company associated with the trading device fees based on the generated report.

10. A method, as set forth in claim 1, further includes the steps of:
sending, from the trading device, a cryptographically-protected certification identifier;
verifying, at the exchange, the cryptographically protected certification identifier against a list maintained by the exchange; and,
validating that software, associated with the tracking device, had been certified by the exchange for operation with the exchange.

11. A system for performing trade orders and trade order verification, comprising:
an exchange; and,
a trading device coupled to the exchange, the trading device being configured to communicate a license key associated with a trading device to the exchange and to generate a trade order relating to one or more tradeable objects traded at the exchange, the exchange being configured to validate the license key against an authorized list, to execute, in response to validation of the license key, the trade order with respect to the one or tradeable objects, and to communicate, to the trading device, a market update related to the trade order.

12. A system, as set forth in claim 11, wherein the trading device has an associated vendor, wherein the license key includes vendor identification information.

13. A system, as set forth in claim 11, wherein the license key includes software identification data associated with trading software running on the trading device.

14. A system, as set forth in claim 13, wherein the software identification data includes at least one of the name of the trading software, a version number of the trading software, and a serial number associated with the trading software.

15. A system, as set forth in claim 11, wherein the trading device is configured to allow a trader to logon to the trading device, wherein the license key is communicated to the exchange during logon.

16. A system, as set forth in claim 11, the exchange being further configured to perform at least one of the following in response to the license key not being validated:
(a) denying the trade order,
(b) providing a warning to a trader associated with the trade order, and
(c) notify a vendor associated with the trading device.

17. A system, as set forth in claim 11, the trading device being further configured to generate and communicate to the exchange multiple trade orders, wherein the license key is communicated to the exchange with each trade order.

18. A system, as set forth in claim 17, the exchange being further configured to track a number of trades executed and to generate a report containing the number of trades executed.

19. A system, as set forth in claim 18, wherein the report includes date and/or time information related to each trade, the exchange being configured to charge a trader or trading company associated with the trading device fees based on the generated report.

20. A system, as set forth in claim 11, the trading device being configured to send a cryptographically-protected certification identifier to the exchange, the exchange being configured to verify the cryptographically protected certification identifier against a list maintained by the exchange and to validate that software, associated with the tracking device, had been certified by the exchange for operation with the exchange.

21. A non-transitory computer-readable information recording medium which stores a program for controlling a computer to performing trade orders and trade order verification at the exchange, the program configured to operate the computer as:
a trading device coupled to the exchange, the trading device being configured to communicate a license key associated with a trading device to the exchange and to generate a trade order relating to one or more tradeable objects traded at the exchange, to execute, in response to validation of the license key against an authorized list at the exchange, the trade order with respect to the one or tradeable objects, and to receive, at the trading device, a market update related to the trade order.
